(19) United States
(12) Patent Application Publication
(10) Pub. No.: US 2012/0245257 A1
(43) Pub. Date: Sep. 27, 2012

(54) Pellet From Recycled Waste

(75) Inventor: Carlo Fascio, Maple (CA)

(73) Assignee: GLOBAL PATENTED TECHNOLOGIES INC., Toronto, ON (CA)

(21) Appl. No.: 13/392,390

(22) PCT Filed: Aug. 26, 2010
(86) PCT No.: PCT/CA10/01320

§ 371 Date: Jun. 4, 2012

(30) Foreign Application Priority Data
Aug. 26, 2009 (CA) 2676961

(51) Int. Cl. C08L 23/06; B05D 7/24; C08L 29/04; C08L 27/06; C08L 33/00; C09D 103/00; C08L 1/00; C08L 77/00; C08L 61/06; C09D 121/00; C09D 133/02; C09D 131/04; B29B 9/04; C08L 75/04

(52) U.S. Cl. 524/35; 264/141; 427/222; 524/586; 524/585; 525/190; 525/132; 525/231; 525/214; 525/240; 525/191; 524/507; 524/502; 524/511; 524/515; 524/527; 524/528; 524/522; 524/524; 524/52

(57) ABSTRACT

This invention provides a pellet derived from recycled waste products in particular from a mixture of two or more of cellulose fibers, recyclable plastic, glass and ceramics and other recyclable products such as tetra paks. The pellets can be used to make a variety of extruded or injection molded products including household trim and moldings, decking, shutters, etc.

### TECHNICAL FIELD

This invention provides a pellet derived solely from recycled municipal, residential, commercial or industrial waste products in particular from a mixture of cellulose fibers, recyclable plastic, glass and ceramics and other recyclable products such as tetra paks. The pellets can be used to make a variety of extruded or injection moulded products including household trim and mouldings, decking, shutters, etc.

### BACKGROUND

Waste disposal is a huge challenge for municipalities, industries, and businesses. It's expensive and time consuming to collect millions of tonnes of trash every year, and there are risks to the environment no matter how we dispose of it.

The ideal situation is to create no waste, but that's difficult to do. The next best solution is to divert waste, through reuse and recycling. Many municipalities have waste management programs that involve recycling and diverting newspapers, cardboard, plastic, aluminum, steel, glass, and polystyrene and other materials. The remaining waste has to be disposed, and the two most common ways to dispose waste are landfilling and incineration. After incineration there is ash that then needs to be disposed of.

Businesses are also being encouraged and in many cases forced by governments to “go green” by reusing, recycling or diverting waste streams. For example the largest waste component of the papermaking process is paper sludge. Pulp and paper mills face a substantial hurdle in finding so-called beneficial uses for what the industry likes to call wastewater treatment residuals. Residuals are wastes coming from the nation's mills that pump out pulp and paper products. Paper sludge is the most plentiful residual to be found. There's no shortage of paper sludge in the United States, and much of that material is burned in boilers at pulp and paper mills that both create some energy. Still more is sent to landfills.

### SUMMARY OF THE INVENTION

The present invention provides a process to form a pellet derived from 100% recycled waste that can be used to extrude or injection mould other useful products.

In one embodiment the present invention relates to a pellet that can be extruded and injection molded derived from a mixture of recycled fiber material, recycled plastic, recycled glass and/or ceramic material and other recycled filler materials. In a preferred embodiment the pellet is made from a municipal residential, commercial or industrial waste stream. The waste stream preferably has been sorted to remove metals, organics, clothing and other items not made of plastic, fiber or glass.

In another aspect the invention relates to a pellet made from a municipal residential, commercial or industrial waste stream wherein the waste stream has been sorted to remove metals, organics, clothing and other items not made of plastic, fiber or glass and from 5 to 50% high density polyethylene. The high density polyethylene is preferably recycled high density polyethylene.

In a further aspect the present invention relates to pellets made from a municipal residential, commercial or industrial waste stream wherein the waste stream has been sorted to remove everything but recycled high density white plastic and fiber materials. The sorted waste stream preferably is 50% recycled high density white plastic and 50% fiber materials. Alternatively the sorted waste stream can be 25% recycled high density white plastic 25% fiber materials and 25% ash.

In another embodiment the pellet of the present invention comprises 5-70% recycled fiber material, 30-95% recycled plastic, 0-50% recycled glass and/or ceramic material and 0-50% other recycled filler materials. Preferred compositions include (1) 50% recycled fiber material preferably paper sludge, 25% recycled plastic and 25% recycled glass and/or ceramic material (2) 50% recycled fiber material preferably paper sludge and 50% recycled plastic (3) 60% recycled fiber material preferably paper sludge and 40% recycled plastic (4) 65% recycled fiber material preferably paper sludge and 35% recycled plastic and (5) 70% recycled fiber material preferably paper sludge and 30% recycled plastic.

The recycled fiber material may be selected from the group consisting of polymers of man-made fiber selected from polyamide nylon, polyesters, phenol-formaldehyde, polyvinyl alcohol fiber, polyvinyl chloride fiber, polyolefins, acrylic fiber, carbon fibers, polyurethane and other resin-based fibers and cellulose fiber. In one embodiment the recycled fiber material is derived from paper sludge.

The recycled plastic may be selected from the following group of resins: ABS, acrylic, high density polyethylene (HDPE), low density polyethylene (LDPE), linear low density polyethylene (LLDPE), Polyethylene terephthalate (PET), poly vinyl chloride (PVC), polypropylene (PP) and polystyrene (PS).

The other recycled filler materials are derived from recycled tetra paks or ash from incineration of municipal, residential, commercial or industrial waste.

In another aspect the present invention relates to a pellet made from a municipal residential, commercial or industrial waste stream wherein the waste stream and for use as a synetetic aggregate wherein the pellet is coated with a coating material selected from the group consisting of a coating material comprised of one or more of the following materials: Paraffin Wax, Microcrystalline Wax, Petrolatum based coatings, Candle Wax, Packaging & Corrugated Waxes, Rubber Coating, Latex waxes, Synthetic Waxes, Polyethylene Waxes, Water based Waxes, Petroleum Wax. Copolymer oxidation inhibitor, Ethylene-vinyl acetate copolymer, ethylene-vinyl acetate copolymer, Biocatalytic Latex Coating, Acrylic acid/vinyl acetate copolymer latexes, Starch based coatings, Synthetic rubber coatings, Mineral based coatings, Vegetable based coatings, Organic based coatings or Liquided based ceramic coatings.

In a further aspect the present invention relates to a method for producing a pellet from a municipal residential, commercial or industrial waste stream that can be extruded and injection molded comprising the following steps:
(a) sorting the waste stream to remove metals, organics, clothing and other items not made of plastic, fiber or glass
(b) grinding the sorted waste stream to form granular material having a particle size that is optimized for drying, mixing and extruding in the next steps,
(c) drying the granular material to less than 1% moisture content;
(e) mixing the granular material under heat and pressure to form a homogeneous melt;
(e) extruding the melt through a die, cooling the extruded melt; and
(f) then forming the extruded melt into pellets of the desired size and shape.

In one embodiment in step (b) the sorted waste stream is ground to a fine fluff then subjected to drying, mixing and extrusion of steps (c) to (e) in a three stage vented extruder.

### BRIEF DESCRIPTION OF THE DRAWINGS

Preferred embodiments of the invention are shown in the drawings, wherein:

FIG. 1 is a schematic illustration of a system and process of producing a pellet from a municipal, residential, industrial or commercial waste stream in accordance with the present invention.

FIG. 2 is a schematic representation of one embodiment of a staged and vented extruder used in the system shown in FIG. 1.

FIG. 3 is a schematic illustration of the pressure development along the extruder of FIG. 2.

FIG. 4 is a schematic illustration of another system and process of producing a pellet from a municipal, residential, industrial or commercial waste stream in accordance with the present invention.

FIG. 5 is a schematic illustration of another system and process of producing a pellet from a municipal, residential, industrial or commercial waste stream in accordance with the present invention.

FIG. 6 is an schematic representation of using a pellet produced in accordance with the process of FIG. 5 as a synthetic aggregate in the production of concrete products, such as the paving stones shown in the Figure.

### DESCRIPTION OF THE PREFERRED EMBODIMENTS

The present invention provides a pellet generally derived from 100% recycled waste that can be used to extrude or injection mold other useful products.

In the context of the present description and appended claims the various terms used herein have the following meanings:

“Ash” means ash remaining after incineration of waste streams.

“melt” means the raw material fed into an extruder after it is heated and softened to the desired molten state that will permit it to be extruded

“municipal, residential, commercial and industrial recycled waste stream” means the various materials that are deposited in recycle programs such as the “blue box” program in Ontario, Canada and waste otherwise sent to landfills or incineration. Each municipality accepts different materials but they may include newspapers and inserts, Mixed paper products, including stationery, computer paper, file folders, envelopes, newsletters, flyers, magazines, catalogues, cereal boxes, detergent boxes, paper towel rolls, toilet paper rolls, greeting cards, paper egg cartons, cardboard, Books (telephone, paperbacks & hardcover),magazines, Boxes (boxboard, sandwich, cereal, shoe, pizza), Bristol Board, bags, calendars, drink or milk cartons, frozen juice containers, tetra paks, Rigid plastic packaging from consumer goods (e.g. electronics, tools), food (e.g. salads, baked goods), empty CD/DVD/VHS protective cases, Rigid plastic containers, including milk jugs, yogurt and margarine containers, shampoo/liquid soap bottles, cleaning product containers, pill/vitamin bottles, clean plant pots, Plastic and metal lids, cans, Glass bottles and jars, Aluminum plates and trays, EMPTY metal paint cans, EMPTY aerosol cans, Foil and foil plates (no food residue), plastic bags etc

“Recycled plastic” for use with the present invention means a product selected from the following group of resins: ABS, acrylic, high density polyethylene (HDPE), low density polyethylene (LDPE), low density polyethylene (LDPE), Polyethylene terephthalate (PET), poly vinyl chloride (PVC or V), polypropylene (PP) and polystyrene (PS). Current recycled plastics most commonly available are products made of PET and HDPE and include plastic bottles, containers and packaging, plastic lumber, etc all of which are identified with one of the acceptable recyclable symbols including:

“high density white plastic” means containers and packaging made from white or translucent plastics such as white detergent containers, windshield washer containers, etc.

“Recycled fiber material” that can be used with the present invention includes polymers of man-made fiber (such as polyamide nylon, polyesters, phenol-formaldehyde, polyvinyl alcohol fiber, polyvinyl chloride fiber, polyolefins, acrylic fiber, carbon fibers, polyurethane and other resin-based fibers) and cellulose fiber About 33 percent of all plant matter is cellulose. For industrial use, cellulose can be obtained from wood pulp and cotton (the cellulose content of cotton is 90 percent and that of wood is 50 percent). Recycled fiber includes cardboard, newspapers etc.

“Recycled glass and/or ceramic materials” for use with the present invention include green glass bottles and containers, brown glass bottles and containers, other coloured glass bottles and containers, composite glass and ceramic materials. Green glass bottles and containers means green-coloured glass containers with or without a redemption value label and includes whole or broken green soda, beer and wine bottles. Brown glass bottles and containers means brown-coloured glass containers with or without a redemption value label including whole or broken brown soda, beer and wine bottles. Other Coloured glass bottles and containers means coloured glass containers and bottles other than green or brown with our without a redemption value label. Composite glass includes Pyrex™, Corning™ ware, crystal, glass tableware, mirrors and auto windshields. Ceramic materials includes any fired ceramic pieces that can be ground into a fine mesh powder. Fine ground glass and/or ceramics are utilized where additional structural strength may be required over a blend of fiber and plastic.

“Other recyclable filler material” includes tetra paks and other materials acceptable for consumer and industrial waste recycling programs and ash and that can be processed into a particle size that can be dried, mixed and extruded in accordance with the present invention. Use of these materials provides a means to dispose of them.

“pellet” means a mass of material in the form of a granule, flake, bead, bullet, cylinder, rods, tubes or other size and shape for the pellet depending on its end use.

“waste residue” means waste otherwise disposed of in landfills or by incineration.

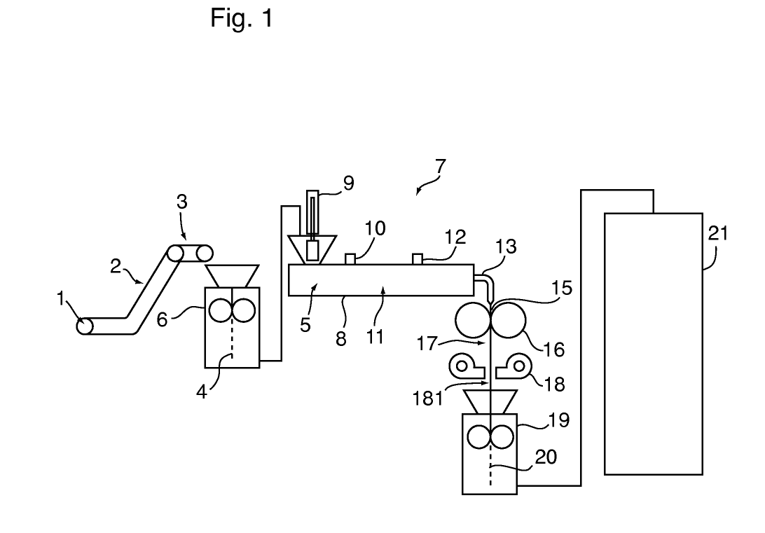

Referring to FIG. 1, one method of utilizing a municipal, residential, commercial or industrial waste stream to produce pellets in accordance with the present invention is illustrated. The waste residue, generally indicated at 1 is delivered and then sorted to remove all metals, organic matter, clothing or other objects not made of plastic or fibre. Sorting 2 can be accomplished using a variety of different methods including hand sorting as the material is moved along a conveyor, magnetic sorting, automated vision sorting systems, automated pick and place vision systems, automated vision blow off systems and magnetic field sorting for non-ferrous metals i.e. aluminum, copper etc. The resulting residue stream after sorting may contain a variety of items including recyclable plastic such as plastic bottles, containers and packaging, recycled glass such as bottles and jars, recycled fiber material such as cardboard, newspapers, paper, paper packaging and other materials found in waste residue.

Once the municipal residential, commercial or industrial waste stream has been sorted, the resulting residue stream 3 is ground to a fine fluff 4 in grinder 6. Grinder 6 can be of any suitable configuration so long as it grinds the municipal residential, commercial or industrial waste stream to a particle size that is optimized for drying, mixing and extruding in the next steps. In the case of the system illustrated in FIG. 1 a particle size of between 0.125″ and 0.1875″ has been found to work well. Suitable grinders are generally available.

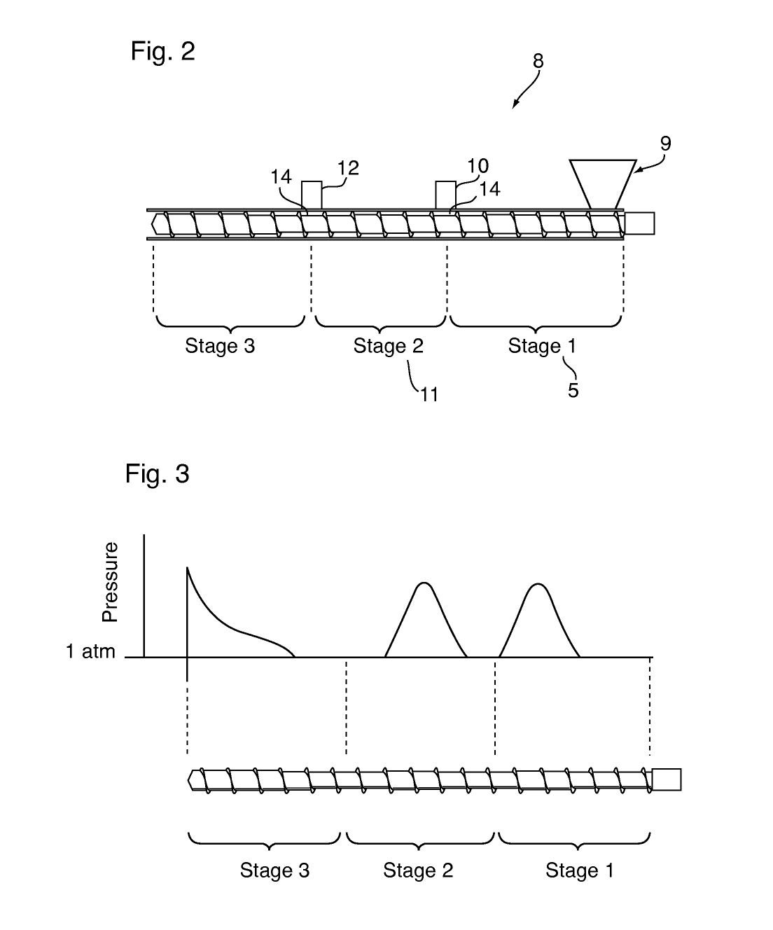

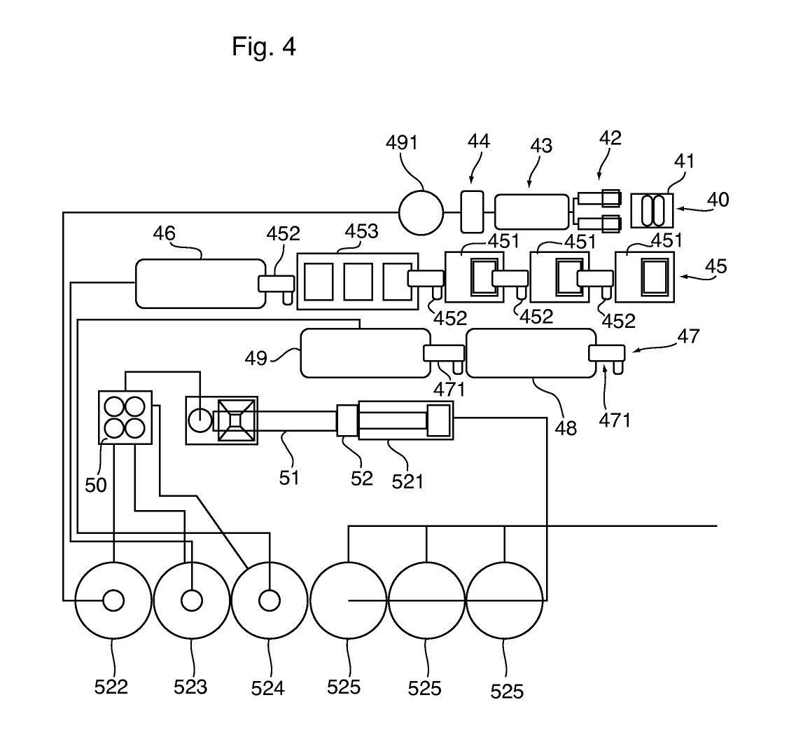

The fluff 4 is then delivered to a drying, mixing and extrusion process generally indicated at 7. In the process illustrated in FIG. 1, the drying, mixing and extrusion process is accomplished using a multi-stage, vented extruder 8, one design of which having three stages and two vents, is shown schematically in FIGS. 2 and 3. The drying, mixing and extrusion process can be carried out in separate apparatus such as in the alternative process shown in FIG. 4 without departing from the scope of the present invention so long as entering the extrusion process, the fluff 4 is a substantially homogenous melt.

As shown in the embodiment illustrated in FIG. 1, the fluff is fed by a ram feeder 9 into the drying, mixing and extrusion process 7 which in this embodiment comprises a three stage, twin vented extruder 8. In the first stage 5, the fluff is mixed and heated, at temperatures above 212° F. and preferably between about 250° F. and 350° F. to reduce the moisture and volatile content of the fluff to 2% or less, preferably 1% or less, by removing moisture, other liquids and volatiles. The resulting gases and water vapor are vented through vent 10.

In the embodiment illustrated in order to insure most of the remaining water and other liquids have been removed, in a second stage 11, the fluff is mixed and heated, at temperatures above 212° F. and preferably between about 250° F. and 350° F. The resulting gases and water vapor are vented through vent 12.

FIG. 3 shows the pressure development as the fluff is heated, dried, and mixed to form a homogenous melt in extruder 8.

When considering the design of the three stage vented extruder the following information was considered. Computing and analyzing the melting capacity of a single screw extruder, enables the barrier melting section of the screw to be designed around its melting capacity. By doing this, the barrier screw design of the extruder shown in FIGS. 1-3 assures that the geometry of the screw matches the melting behaviour of the waste material to be extruded. Because the screw geometry is fixed once the screw is manufactured, the screw design should consider how the screw melting behaviour will be affected by changes in processing conditions. These include changes in melt feed properties, motor speed, back pressure and changes in the temperature profile of the barrel heaters along the screw.

The barrier screw design in the Figures involves determining how large the melt and solids channel should be in order to accommodate the melt that is being generated. The first step in achieving this is to determine the melting capacity of the barrier screw. This can be estimated from the thermal and material properties of the melt as well as process related variables including screw speed, barrel temperature settings and the surface area where the solid bed is exposed to the barrel. By calculating the melting capacity along the axis of the screw it is possible to determine the volume of melt that is being generated at any point along the screw.

The present vented screw design is essentially three screws in one. Note in FIG. 2 the increase in the channel volume 14 under the vents 10, 12. This reduces the melt pressure to atmospheric to prevent the melt from being pumped out the vent opening. The extruder feed screw construction features, preferably include:
Chrome plating in root
Wear resistant full flight width Colmonoy 56, 83, X830, or UCAR
Spiral or straight Maddock mixing section for dispersive mixing
Pineapple, Saxton, or pin mixing section for distributive mixing
Highly polished streamlined surfaces

High quality materials and construction (manufactured from aircraft quality 4140, 4340, stainless steel or Duranickel)

The vented three stage screw design of the present invention optimizes the removing of volatiles and moisture in applications where volatiles and moisture must be removed in order to make a satisfactory product. Standard screws have a number of disadvantages that are off set only if volatile removal is essential to proper operation. Primary and foremost is the problem of vent leakage. Second is a loss of output due to the need to design the screw to accommodate an open vent. Third, there is always a likelihood of contamination developing from the unfilled flights in the vent. Finally, vented screws can be unstable if the final metering section is not adequately filled.

The vented screw reduces the melt pressure to atmospheric adjacent the vents, so there is no tendency for the residue polymer to be pumped out the vent opening. This is accomplished by increasing the channel volume adjacent the vents so that the output of the extruder only partially fills the flights under the vent.

The vented three-stage screw of this invention is essentially three screws on the same shaft. The first works as a conventional screw by feeding, melting, mixing and conveying the polymer forward. The second screw does the same, except it is melt-fed by the first screw. The third screw does the same, except it is melt-fed by the second screw. The first screw operates with no head pressure, while the second has to melt and mix the residue melt to remove moisture and volatiles. The third screw has to overcome any head pressure from the die and other downstream components. In order to keep the vent section of the screw from filling and developing vent flow, the second and third screw must have more output capacity than the first screw. Proper design of a three-stage screw requires knowledge of the polymer viscosity, the output capacity of all three stages, and the head pressure. Simply using a ratio in channel depths between the first and second metering sections is risky.

Proper venting with no leakage or vent flow does not depend solely on the design of the screw. The barrel vent opening has to be fitted with a contoured plug called a diverter. The diverter deflects polymer away from the opening or else it will quickly become filled with melt. Its design is more of an art than a science but there are many variations that work, all using the same principles.

The screw has to be partially filled or the diverter cavity would be overcome with the melt, which would block the opening. However, there has to be some melt touching the barrel wall or there will be no forwarding of the material. The melt does not simply lay down in the screw channel, so there is always a necessary balance between the volume of the diverter cavity and the width of the melt bank, which is proportional to the output of the first stage of the screw. The shape of the bank depends on the polymer viscosity, but in general, if the portion of melt touching the barrel wall exceeds one-third of the channel width, there will be difficulty keeping the vent open.

Most vents are located on the left side of the extruder (looking downstream). Top vents work well but in case of any vent flow, the melt will run all over the barrel and is hard to access. A right-hand vent would have gravity pulling the residual material left in the diverter cavity down into the opening, making it more difficult to maintain an open vent, particularly when the extruder stops.

In the present inventor's experience, vent flow is more frequently caused by the design of the diverter than that of the screw. One can often tell what the problem is by watching the material flow out of the vent. A screw design that has too much melt in the vent area will tend to extrude material in a steady stream out the vent. A diverter that is not properly designed will tend to show a pulsing action that corresponds perfectly with the screw speed.

Venting in single screw extrusion is most typically done through a single vented barrel, whereas the present design shown in FIG. 1 uses a three-stage screw with a twin vented barrel that significantly removes all the volatile vapours and moisture vapours from the melt.

In FIG. 1, the dried and heated fluff is fed to stage three where under heat and pressure, the fluff is continued to be mixed to form a generally homogenous melt that can be extruded through a die. In the embodiment illustrated the die is a sheet die 13.

The extruded hot melt 15 is passed through chill rollers 16 to calendar the melt into a flat sheet 17 that is further cooled. In the embodiment shown in FIG. 1 air blowers 18 further cool the sheet 17 to solidify the melt. While the present embodiment illustrates the use of chill rollers and air blowers to cool and solidify the extruded melt other known methods can be used. In addition as will be apparent on review of FIG. 4 it is not necessary to the operation of the present invention that the melt be extruded to form a sheet. Other forms of extrusion are possible.

The solidified melt 181 is then fed into a grinder 19 to produce a granulate 20 having the shape and size desired for the intended application of the pellet. In the embodiment illustrated the granulate 20 is intended to be injection molded into various parts. For this application, the grinder is set up to produce granulate between 0.125 inches and 0.1875 inches in diameter. The granulate 20 is then delivered to a storage bin/silo 21.

As noted the size and shape and composition of the granulate produced from municipal, residential, commercial and/or industrial waste in accordance with the present invention can vary widely subject to its intended use.

In one embodiment the 100% municipal waste stream after sorting to remove metals, organics, and other products not made from plastics or fiber can be mixed with from 5-50% high density polyethylene, preferably up to 10% recycled high density polyethylene, before feeding to the initial grinding operation. The process in this case will produce a granulate that may be used for producing extruded or injection molded products at a low cost.

In another embodiment the 100% municipal waste stream after sorting to remove everything but recyclable high density white plastic and recyclable fiber materials, will produce a high quality, durable material that on extrusion or molding can be coloured. The granulate can be used to extrude or injection mold higher quality products. In a preferred embodiment the waste stream fed to the first grinder is at least 50% recycled high density white plastic and up to 50% fiber material.

In a still further embodiment, the material stream going to the first grinding step can be at least 25% recycled high density white plastic, up to 25% fiber material and up to 25% ash.

The present invention includes a pellet produced from a mixture of recycled fiber material, recycled plastic, recycled glass and/or ceramic material and other recycled filler materials. In one embodiment the pellet consists of 5-70% recycled fiber material, 30-95% recycled plastic, 0-50% recycled glass and/or ceramic material and 0-50% other recycled filler materials. Various combinations of materials have blended into a pellet then injection moulded in a thin walled mould to test the flowability of the melt and the strength of the resulting products. Different formulations tested included (a) 50% recycled fiber material preferably paper sludge, 25% recycled plastic and 25% recycled glass and/or ceramic material (b) 50% recycled fiber material preferably paper sludge and 50% recycled plastic (c) 60% recycled fiber material preferably paper sludge and 40% recycled plastic (d) 65% recycled fiber material preferably paper sludge and 35% recycled plastic and (e) 70% recycled fiber material such as paper sludge and 30% recycled plastic.

In a preferred embodiment, a cellulose fiber derived from sludge paper is utilized. Sludge paper refers to fibrous material prepared by chemically or mechanically processing the fibers from fiber crops. Included are mechanical pulp, chemical pulp made by the Kraft process or by sulfite processing and pulp recycled from industrial and consumer waste.

Another method of making the pellets of the present invention is shown in FIG. 4 and includes the following steps. The recycled fiber material 40 typically must be dried to reduce the moisture content to preferably less than 1% moisture content. When utilizing paper sludge for example as the recycled fiber material it can first be dyed any custom colour that is required for the finished pellet in pulper 41. The dyed paper sludge is then dewatered in screw press 42 and dried in dryer 43 at a temperature between about 250° F. and 350° F. for about 60 to 120 minutes, to sterilize the sludge and reduce the moisture content to less than 5%. If drier material with less than 5% moisture is used the fiber material can proceed directly to the next step.

The dried fiber material is then ground into a fine powder, sifted and the larger particles re-ground to a uniform particle size similar to the consistency of baking flour in micronizer 44 and then may be further dried in a dryer (not shown) at a temperature between about 250° F. and 350° F. for about 30 minutes, to reduce the moisture content to preferably 1% or less.

The recycled plastic and other recycled filler materials 45 are shredded, washed and then dried in dryer 46, and then shredded separately into a fine powder.

The ash raw material stream 47 is dried in ash dryer 48 and then sifted in ash sifter 49.

The processed fiber material, powdered plastic and ash are then blended in blend mixer 50 and fed to extruder 51. The various components, recycled fiber material, recycled plastic, and other recycled filler materials in their powder forms are blended together in the desired amounts, the mixture is heated to a temperature between about 250° F. and 350° F. and then extruded into a pellet for example using a twin screw extruder/pelletizer 51/52. The extruded pellets are cooled for example in a water bath (not shown) and stored.

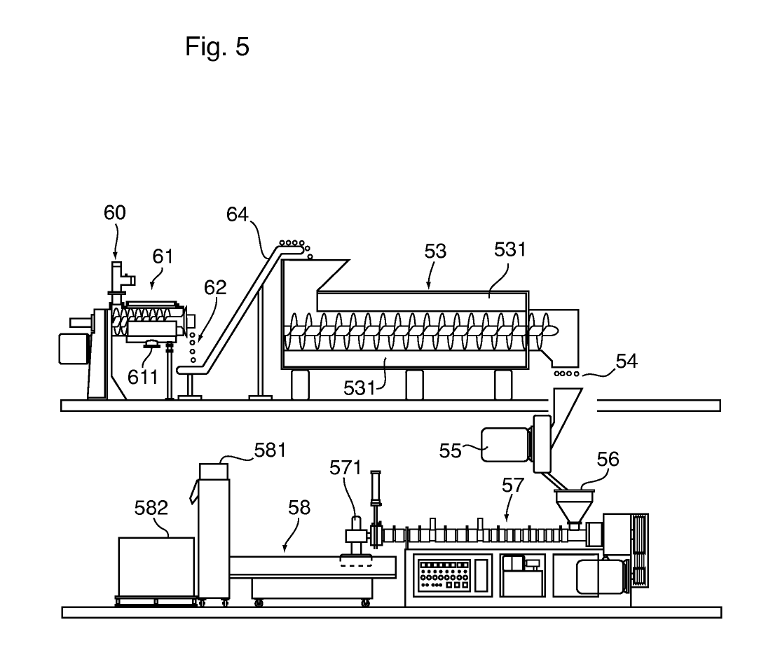

Another method of producing a granulate according to the present invention is shown in FIG. 5. In FIG. 5 a combined recycled fiber material and ash raw material stream 60 having less than 6% moisture is fed through a screw press 61 to produce a partially dried fiber/ash stream 62. Partially dried fiber/ash stream 62 is then fed to a hi-output dryer 53 to reduce the moisture content to 1% or less than in the dry fiber/ash stream 54. In the embodiment shown the hi-output dryer is an inline auger and feed screw dryer using super heated thermo oil as a heat source.

The dry fiber/ash stream 54 is then ground into a fine powder, sifted and the larger particles re-ground to a uniform particle size similar to the consistency of baking flour in micronizer 55.

The dry fiber/ash material, recyclable plastic and recyclable glass and other recyclable materials all of which have been ground to a powder are blended and fed, in FIG. 5 to hopper and then in to pelletizing extruder 57. The various components, recycled fiber material, recycled plastic, recycled glass and/or ceramic material and other recycled filler materials in their powder forms are blended together in the desired amounts, the mixture is heated to a temperature between about 250° F. and 350° F. and then extruded into a pellet for example using a twin screw extruder/pelletizer 57. The extruded pellets are cooled for example in a water bath 58 and stored.

Where the intended application of the pelletized material requires any exposed fiber in the pellet not to absorb water, the water bath 58 can include a coating material comprised of one or more of the following materials: Paraffin Wax, Microcrystalline Wax, Petrolatum based coatings, Candle Wax, Packaging & Corrugated Waxes, Rubber Coating, Latex waxes, Synthetic Waxes, Polyethylene Waxes, Water based Waxes, Petroleum Wax. Copolymer oxidation inhibitor, Ethylene-vinyl acetate copolymer, ethylene-vinyl acetate copolymer, Biocatalytic Latex Coating, Acrylic acid/vinyl acetate copolymer latexes, Starch based coatings, Synthetic rubber coatings, Mineral based coatings, Vegetable based coatings, Organic based coatings or Liquided based ceramic coatings. Alternatively coating the pellet can be done in a separate step.

One use of the coated pellet is as a synthetic aggregate. It is important that the pellet does not absorb moisture in this application. Absorbing water will cause the concrete mixture to lose strength and durability. Accordingly by coating the pellet as noted above any of the fiber material that is exposed on the surface of the pellet will not absorb moisture.

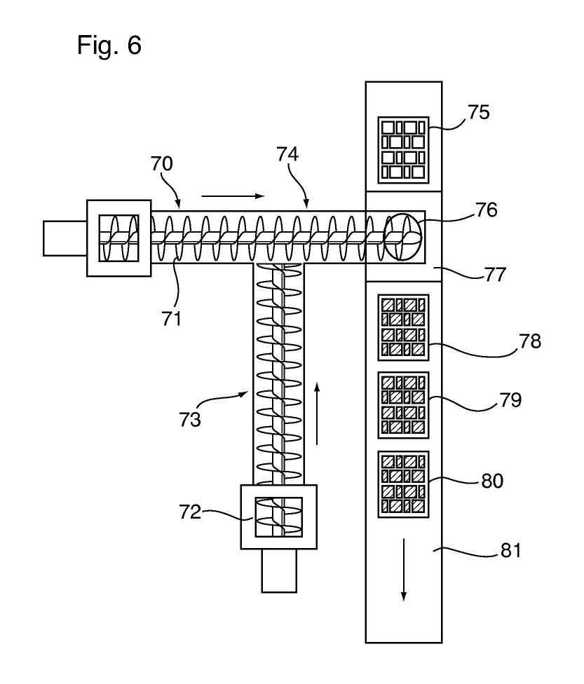

FIG. 6 shows schematically one possible way of using pellets of the present invention as a synthetic aggregate in the production of molded products such as concrete pavers. Concrete or a binder enters the mixing chamber 70 by feed screw 71. The synthetic aggregate 72 enters the metering feed screw 73. The synthetic aggregate 72 is fed to the mixing zone 74 The mixture is then proportionally metered on to the mould 75 through the discharge port 76 on to a waiting mould sitting on the vibrating table 77 Filled moulds 78, 79, 80 travel down roller conveyor 81 to de-moulding station (not shown). The synthetic aggregate is proportionally metered into the blend in the mixing zone 74 by way controlling the screw feed rate of both feed screws 71, 73. When used as a synthetic aggregrate the pellets should be 0.25″ to 0.50″ in diameter. It is also preferably that the pellets have an irregular shape that can bind with he concrete or other binder.

Uses

The pellets of this invention can be injection molded or extruded into numerous products. A small sampling of products includes Decorative door trim, Cornice moldings, Gardening Tools, Green Recycling Bins, Composite Decking, Composite Hand Railing Systems, Window Shutters, Furniture components and Automotive Sub Assemblies etc.

The materials described in this disclosure can be effectively modified by routine optimization without departing from the spirit of the invention embodied in the claims that follow.

It is to be understood by one of ordinary skill in the art that the present discussion is a description of exemplary embodiments only, and is not intended to limit the broader aspects of the present invention.

Although various preferred embodiments of the present invention have been described herein in detail, it will be appreciated by those skilled in the art, that variations may be made thereto without departing from the spirit of the invention or the scope of the appended claims

1. A pellet that can be extruded and injection molded derived from a mixture of two or more of the materials selected from the group consisting of recycled fiber material, recycled plastic, recycled glass and/or ceramic material and other recycled filler materials.

2. A pellet according to claim 1 made from a municipal residential, commercial or industrial waste stream.

3. A pellet according to claim 2 wherein the waste stream has been sorted to remove metals, organics, clothing and other items not made of plastics or fiber.

4. A pellet according to claim 1 made from a municipal residential, commercial or industrial waste stream wherein the waste stream has been sorted to remove metals, organics, clothing and other items not made of plastic, or fiber and from 5 to 50% high density polyethylene.

5. A pellet according to claim 4 wherein the high density polyethylene is recycled high density polyethylene.

6. A pellet according to claim 1 made from a municipal residential, commercial or industrial waste stream wherein the waste stream has been sorted to remove everything but recycled high density white plastic and fiber materials.

7. A pellet according to claim 6 wherein the sorted waste stream is 50% recycled high density white plastic and 50% fiber materials.

8. A pellet according to claim 3 wherein the sorted waste stream is 25% recycled high density white plastic 25% fiber materials and 25% ash.

9. A pellet according to claim 1 comprising 5-70% recycled fiber material, 30-95% recycled plastic, 0-50% recycled glass and/or ceramic material and 0-50% other recycled filler materials.

10. A according to claim 9 comprising 50% recycled fiber material preferably paper sludge, 25% recycled plastic and 25% recycled glass and/or ceramic material.

11. A pellet according to claim 9 comprising 50% recycled fiber material and 50% recycled plastic.

12. A pellet according to claim 9 comprising 60% recycled fiber material and 40% recycled plastic.

13. A pellet according to claim 9 comprising 65% recycled fiber material and 35% recycled plastic.

14. A pellet according to claim 9 comprising 70% recycled fiber material and 30% recycled plastic.

15. A pellet according to claim 9 wherein the recycled fiber material is selected from the group consisting of polymers of man-made fiber selected from polyamide nylon, polyesters, phenol-formaldehyde, polyvinyl alcohol fiber, polyvinyl chloride fiber, polyolefins, acrylic fiber, carbon fibers, polyurethane and other resin-based fibers and cellulose fiber.

16. A pellet according to claim 15 wherein the recycled fiber material is derived from paper sludge.

17. A pellet according to claim 15 wherein the recycled plastic is selected from the following group of resins: ABS, acrylic, high density polyethylene (HDPE), low density polyethylene (LDPE), linear low density polyethylene (LLDPE), Polyethylene terephthalate (PET), poly vinyl chloride (PVC), polypropylene (PP) and polystyrene (PS).

18. A pellet according to claim 15 wherein the other recycled filler materials is derived from recycled tetra paks.

19. A pellet according to claim 3 for use as a synthetic aggregate wherein the pellet is coated with a coating material selected from the group consisting of a coating material comprised of one or more of the following materials: Paraffin Wax, Microcrystalline Wax, Petrolatum based coatings, Candle Wax, Packaging & Corrugated Waxes, Rubber Coating, Latex waxes, Synthetic Waxes, Polyethylene Waxes, Water based Waxes, Petroleum Wax. Copolymer oxidation inhibitor, Ethylene-vinyl acetate copolymer, ethylene-vinyl acetate copolymer, Biocatalytic Latex Coating, Acrylic acid/vinyl acetate copolymer latexes, Starch based coatings, Synthetic rubber coatings, Mineral based coatings, Vegetable based coatings, Organic based coatings or Liquided based ceramic coatings.

20. A method for producing a pellet from a municipal residential, commercial or industrial waste stream that can be extruded and injection molded comprising the following steps:
(a) sorting the waste stream to remove metals, organics, clothing and other items not made of plastic or fiber;
(b) grinding the sorted waste stream to form granular material having a particle size that is optimized for drying, mixing and extruding in the next steps,
(c) drying the granular material to 2% or less moisture content;
(d) mixing the granular material under heat and pressure to form a generally homogeneous melt;
(e) extruding the melt through a die, cooling the extruded melt:, and
(f) then forming the extruded melt into pellets of the desired size and shape.

21. A method according to claim 20 wherein in step (b) the sorted waste stream is ground to a fine fluff.

22. A method according to claim 21 wherein the fine fluff is subjected to drying, mixing and extrusion of steps (c) to (e) in a three stage, vented extruder.

23. A method according to claim 22 wherein the homogeneous melt is extruded through a sheet die.

24. A method according to claim 23 wherein to form the extruded melt into pellets the extruded melt is passed through chill rollers to calendar the melt into a flat sheet that is further cooled then ground to produce pellets.

25. A method according to claim 24 wherein the pellets are coated with a coating material selected from the group consisting of a coating material comprised of one or more of the following materials: Paraffin Wax, Microcrystalline Wax, Petrolatum based coatings, Candle Wax, Packaging & Corrugated Waxes, Rubber Coating, Latex waxes, Synthetic Waxes, Polyethylene Waxes, Water based Waxes, Petroleum Wax. Copolymer oxidation inhibitor, Ethylene-vinyl acetate copolymer, ethylene-vinyl acetate copolymer, Biocatalytic Latex Coating, Acrylic acid/vinyl acetate copolymer latexes, Starch based coatings, Synthetic rubber coatings, Mineral based coatings, Vegetable based coatings, Organic based coatings or Liquided based ceramic coatings.

26. A method according to claim 24 wherein the flat sheet is ground to between 0.125 inches and 0.1875 inches in diameter.

27. A method for producing a pellet that can be extruded and injection molded derived from a mixture of recycled fiber material, recycled plastic, recycled glass and/or ceramic material and other recycled filler materials, comprising the following steps:
(a) drying the recycled fiber material to 2% or less moisture content;
(b) grinding the recycled fiber material, recycled plastic, recycled glass and/or ceramic material and other recycled filler materials into powders having a required particle size to ensure proper admixture;
(c) mixing the recycled fiber material, recycled plastic, recycled glass and/or ceramic material and other recycled filler materials in their powder forms in the desired quantities;
(d) heating the mixture to a temperature between about 350° F. and 250° F. and then extruding into pellets;
(e) cooling the extruded pellets.
